(19) United States
(12) Patent Application Publication
(10) Pub. No.: US 2010/0176601 A1
(43) Pub. Date: Jul. 15, 2010

(54) BEARING ARRANGEMENT FOR A WIND TURBINE

(75) Inventors: Georgios Pechlivanoglou, Berlin (DE); Jürgen Wagner, Berlin (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: SUZLON WINDKRAFT GMBH, Berlin (DE)

(21) Appl. No.: 12/602,224

(22) PCT Filed: Jun. 3, 2008
(86) PCT No.: PCT/EP2008/004426

§ 371 Date: Nov. 30, 2009

(30) Foreign Application Priority Data
Jun. 4, 2007 (EP) 07090108.7
Nov. 23, 2007 (DE) 10 2007 056 763.6

(51) Int. Cl. F03D 11/00; F16C 17/10

(52) U.S. Cl. 290/55; 384/456

(57) ABSTRACT

The invention relates to a bearing arrangement, especially for a wind turbine, for transmitting radial and axial forces, two bearing partners being provided that are twistable relative to one another about an axis. The bearing partners each comprise a support area, between which a bearing block is arranged to be insertable in an actuating direction in order to generate a normal force that acts upon the support areas. The bearing block is connected in a rotationally fixed manner to one of the bearing partners. The aim of the invention is to design an improved bearing arrangement which overcomes the drawbacks of the prior art. In particular, the aim is to design a wear-resistant and maintenance-friendly bearing arrangement for an azimuth bearing of a windturbine. Furthermore, an optional aim of the invention is to make it possible to simultaneously use the bearing arrangement as an active brake. Said aim is achieved by the features of independent claim 1, according to which a friction lining is disposed between the bearing block and the bearing partner that can be twisted relative to the bearing block. For the first time, this design makes it possible to represent a support of a bearing ring and a bearing rim, the bearing clearance being easy to adjust.

The invention relates to a bearing arrangement, especially for a wind turbine, for transmitting radial and axial forces, whereas two bearing partners are provided that are twistable relative to one another about an axis. The bearing partners each comprise a support area, between which a bearing block is arranged to be insertable in order to generate a normal force that acts upon the support areas. The bearing block is connected in a rotationally fixed manner to one of the bearing partners. In wind turbines such bearing arrangements are arranged in between the tower of the wind turbine and the nacelle and, among other things, are used for reception and transfer of thrust load, gyroscopic forces and gear forces from the machine carrier 7 of the nacelle into the tower. The yaw control of the nacelle is realised by means of the bearing arrangement, the so-called azimuth bearing and the azimuth drive. In doing so the nacelle is rotated in the horizontal plane about a mainly vertical axis in such a manner that the wind blows vertical to a rotational plane of the rotor and as a result the recovery of energy is maximised.

DE 10 2005 039 434 A1 discloses such a bearing arrangement for a wind turbine. Here various types of arrangements of azimuth bearings are mentioned whereas one embodiment of the invention comprises the features as stated in the generic part of the main claim. The azimuth bearing comprises a bearing rim which is securely screwed to the tower and which is axially encompassed by a bearing ring. The bearing ring is closely connected to the nacelle and rests upon the bearing rim. By means of slide linings which are provided in between the bearing rim and the bearing ring the bearing clearance and a pretension between both of the bearing partners are adjustable. For this a spindle is designed with which a radial position of the slide lining is definable. The present bearing arrangement is used at the same time as a passive brake in between the nacelle and the tower since the pretension between the bearing partners is chosen to be great enough so that the tangential forces resulting during operation can not lead to a twisting of the nacelle. If a rotation of the nacelle is desired azimuth drives generate a torque which overcomes the stick moment between the bearing partners and as a result the nacelle can moved. This is inconvenient since the azimuth drives have to be designed potent enough so that they are capable of overcoming the stick moment of the bearing arrangement. Furthermore the azimuth drives must comprise an independent brake system which is used to control the speed of the rotation of the bearing arrangement. The azimuth drives can also be use to prevent the nacelle from an undesired twist in case environmentally evoked high torques—for example as a result of a gust—threaten to overcome the stick moment of the passive brake system. In doing so tangential forces are transferred via the gearing of the azimuth drives whereby the gearing is heavily loaded.

One aim of the invention is to provide an improved bearing arrangement which among other things overcomes the drawbacks of the prior art. In particular the aim is to design a wear-resistant and maintenance-friendly bearing arrangement for an azimuth bearing of a wind turbine. Furthermore an optional aim of the invention is to make it possible to simultaneously use the bearing arrangement as an active brake.

According to the invention said aim is achieved by the features of independent claim 1, according to which a friction lining is arranged between the bearing block and the bearing partner which is twistable relative to the bearing block. For the first time, this design makes it possible to represent a support of a bearing ring and a bearing rim, the bearing clearance being easy to adjust. Furthermore, the bearing arrangement is representable by a bearing block functioning as a brake or a slide bearing, whereas both the exclusive usage as bearing without an active brake and the combined simultaneous usage as a bearing and as an active brake are within the scope of the invention.

The braking means and the bearing means can engage with the same support area of a bearing partner whereby furthermore the effort, the complexity and possibly also the number of components of the construction is reduced.

Since the friction lining is connected in a rotationally fixed manner to a bearing partner and is workable as brake lining or slide lining the production costs can be reduced significantly because generally similar or the same components are used and a differentiation of the devices as an active brake or as a slide bearing is be carried out mainly by the design of the friction linings. In case the friction lining in combination with the bearing partner that is not connected in a rotationally fixed manner, comprises a high friction coefficient that is in particular greater than 0.3, this lining has to be called brake lining and will be used respectively. This means that in non-braked operation a high normal force between the bearing partners and the brake lining has to be avoided. If an active brake activation or a locking of the bearing arrangement is desired, a high normal force is established by means of the bearing block between the bearing partners which in co-operation with the brake linings results in a high brake momentum and a high holding torque. In order to use the arrangement according to the invention as a slide bearing the friction lining, as a slide lining, has to be designed with a low friction coefficient preferably smaller than 0.09. In doing so, a normal force acting between the bearing partners or rather a pre-tensioning force will be adjusted to a constant value during operation by means of the bearing block so that the bearing arrangement works free of clearance. Since the friction lining is designed as a slide lining with a lower friction coefficient, the pre-tensioning force provokes only a small brake momentum.

According to a preferred embodiment of the invention the bearing block is designed wedge-shaped in a radial sectional plane, the bearing block comprising a first bearing area facing the first bearing partner and a second bearing area facing the second bearing partner. The bearing areas run anti-parallel to each other. This anti-parallelism of the bearing areas provokes in co-operation with the support areas of the bearing partners that the actuation force exhibited on the bearing block is intensified by the wedge effect of the anti-parallel areas. The wedge effect of the bearing areas beneficially affects the functionality of the bearing arrangement if the wedge angle β, which is included between the bearing areas, is between 3° and 10° degree, and preferably equals 4° degree.

According to one embodiment of the invention each of the support areas of the bearing partners run parallel to the respective bearing areas at the bearing block in case that the friction lining is designed as slide lining that is arranged at the bearing area of the bearing block and faces the bearing partner which is twistable with respect to the bearing block. This way and due to the distribution, the surface pressure is kept low.

According to a further development of the invention the support area of the bearing partner which is arranged in a rotationally fixed manner with respect to the bearing block runs anti-parallel to the axis and includes along with the axis of the bearing arrangement an angle α between 3° and 10° degree preferably 4° degree. This way a purely radial transfer of forces between the support areas can be guaranteed in case the wedge angle of the bearing block equals the angle of inclination of the torque proof support area with respect to the axis. This has to be regarded as an advantage since the adjustment of the pre-tensioning forces and clearances in radial and axial direction can be executed absolutely independently from one another.

According to a further embodiment of the invention the friction lining is designed as brake lining. Furthermore the brake lining and the bearing block are designed as independent components, whereas one side of the brake lining which is facing the bearing block comprises a lining-support-area. The latter can be charged by the bearing block and runs parallel to the second bearing area. Thus the bearing block and the brake lining are not completely geometrically interdigitated and therefore mainly exclusively pressure forces can be transmitted in a form fit manner between the brake lining and the bearing block. According to a partitioning of the transfer of forces, tangential forces are directly transferred from the friction lining into the bearing partner that is connected in a rotationally fixed manner to the friction lining, without the bearing block being charged with essential fractions of the tangential force.

If the support area of the bearing partner, which is rotably arranged with respect to the bearing block, runs parallel to the axis, no axial transfer of forces can take place between the bearing partners via the support area in a form fit manner. The advantage is that the radial pre-tensioning and the radial clearance are adjustable independently from the axial clearance. Furthermore, this arrangement provokes that during the active braking process of the bearing arrangement, no undesired axial loadings exist between the bearing partners. The support area of the bearing partner which is arranged in a rotationally fixed manner with respect to the bearing block can run anti-parallel to the axis and includes along with the axis an angle γ between 3° and 10° degree particularly 4° degree. The wedge effect can be achieved alternatively by aligning the lining-support-area anti-parallel to the axis whereas an angle between 3° and 10° degree particularly 4° degree is included between the lining-support-area and the axis.

Since at least at one of the bearing areas of the bearing block, preferably at both, a slide lining or slide coating is provided that comprises a low friction coefficient, the advantageous wedge effect can be used and no jamming of the wedge shaped bearing block in between the bearing partners caused by sticking friction takes place. A jamming takes place when an axial retracting force is smaller than the sum of the sticking frictions between the bearing areas of the bearing block and the respective support areas. The sticking friction between the slide lining and the support area can be reduced by means of suitable material or by means of a coating, for instance with Teflon or with plastic material. Consequently the described embodiment results in relatively low actuation forces and also in relatively low releasing forces of the brake.

Another embodiment of the invention improves the functionality of the bearing block between the bearing partners even more by providing means for rolling motion of a translatory relative movement of the bearing block and the bearing partner or the brake lining at least between the bearing block and the lining-support-area or between the bearing block and the support area. These means for rolling motion span a plane which substitutes the bearing areas and which comprise the same spatial alignment as the bearing areas. In doing so the tendency for jamming of the bearing block reduced even more since only the rolling friction of the means has to be overcome while releasing the brake.

According to an embodiment of the invention an adjustment device is provided in order to adjust and to readjust a defined position of the bearing blocks between the bearing partners. In doing so the clearance between the bearing partners is adjustable according to the geometrical conditions and manufacturing tolerances so that an optimal operation of the azimuth bearing of the wind turbine is guaranteed. For this purpose adjustment screws can be used for example.

A further embodiment of the invention comprises an adjustment device in order to vary the axial position of the bearing block during operation. By moving the bearing block, the effective normal or pre-tensional force or the clearance between the bearing partners can be raised or reduced as and when required. The wedge shaped design of the bearing block transforms in co-operation with the referring support area an axial movement into a radial movement by intensification of force. In this manner an active braking system is provided in the end.

Furthermore, the automatic actuation device could comprise a pneumatic muscle. Preferably, for reasons of safety, the actuation device is designed in such a way that a spring arrangement biases the bearing block in such a manner that it is pressed between the support areas. By this the active brake is closed and the bearing arrangement cannot rotate. The pneumatic muscle can be arranged in such a manner that it acts against the spring force of the spring arrangement, whereas the pneumatic muscle overcomes the spring force on being actuated, pulls out the bearing block between the bearing partners and in doing so, opens the brake.

According to an additional embodiment of the invention the bearing arrangement comprises at least two friction linings whereas one friction lining is designed as brake lining and one friction lining as slide lining. Thus, the bearing and a device for braking or locking are simultaneously integrated in one bearing arrangement. The braking device and the slide bearing can engage at the same time at the same support area of a bearing partner whereby furthermore the effort, the complexity and possibly also the number of components of the construction is reduced.

Another detail of the invention—not shown in the figures as the verbal description is considered sufficient—considerably reduces the production costs of the bearing arrangement by providing in one of the bearing partners a mounting device for the bearing block with actuation device and a mounting device for the bearing block with an adjustment device whereas the mounting devices are basically designed similar. In this special case we are talking about boreholes inside the bearing ring, in which both the automatic actuation device and the adjustment device can be mounted. By this the mounting devices can be mounted in a single manufacturing step using the same manufacturing tool, whereby time effort as well as manufacturing tool investment is reduced.

According to an alternative embodiment the brake device with the respective bearing block and the bearing block which functions as a radial bearing, does not engage at the same support area of a bearing partner, especially of the rotating rim. Therefore the bearing partner designed as rotating rim comprises two bearing areas whereas one is engaged by the braking device and one by the radial bearing. This makes sense in particular if different lubricants are used for both devices and are not supposed to interact.

Preferably the embodiments of bearing arrangements described above can be used in wind turbines which comprise a nacelle rotatably mounted about an axis on a tower. Between the tower and the nacelle this bearing arrangement is designed partly or completely in concordance with the above described different embodiments. Here the enormous advantages of the bearing arrangement become very clear, since extremely high loads and moments occur in these kinds of wind turbines. There is an obvious conflict of aims of providing a smooth-running and largely vibration-free bearing on the one hand, being controllable by braking devices and adjustable bearing blocks on the other hand.

In the scope of the present invention a method for the operation of a wind turbine according to the embodiments described above, is disclosed. In this context a controlling device of the wind turbine detects an actual value of the horizontal orientation of the nacelle and compares this value to a desired value. If the actual value differs from the desired value by more than a predetermined amount, the following steps will be executed:

moving of the bearing block according to a predetermined amount by activating the actuation device,

yawing of the nacelle by activating of a azimuth drive,

comparing the actual value to the desired value

and inserting the bearing block between the bearing partners by deactivating the actuation device in case that the difference between the actual value and the desired value equals a certain amount.

Said method steps are not interpretable as limiting. In fact further reasonable method steps can broaden and improve the method according to the invention.

Further details of the invention are disclosed in the description of the drawings.

### DRAWINGS

FIG. 1 shows a perspective view of a bottom side of a first embodiment of a bearing arrangement,

FIG. 2 shows a detailed view of an upper side of the bearing arrangement according to FIG. 1,

FIG. 3 shows an axial view of the bottom side of the bearing arrangement according to FIG. 1,

FIG. 4 shows a sectional view of the bearing arrangement along line A-A according to FIG. 3,

FIG. 5 shows a sectional view of the bearing arrangement along line B-B according to FIG. 3,

FIG. 6 shows an exploded view of the brake lining of FIG. 5,

FIG. 7 shows the distance plate with anti-twist protection of FIG. 5,

FIG. 8 shows a perspective view of the locking plate and the distance ring of the bearing arrangement according to FIG. 1 and

FIG. 9 shows the essential components of an alternative embodiment of a bearing arrangement.

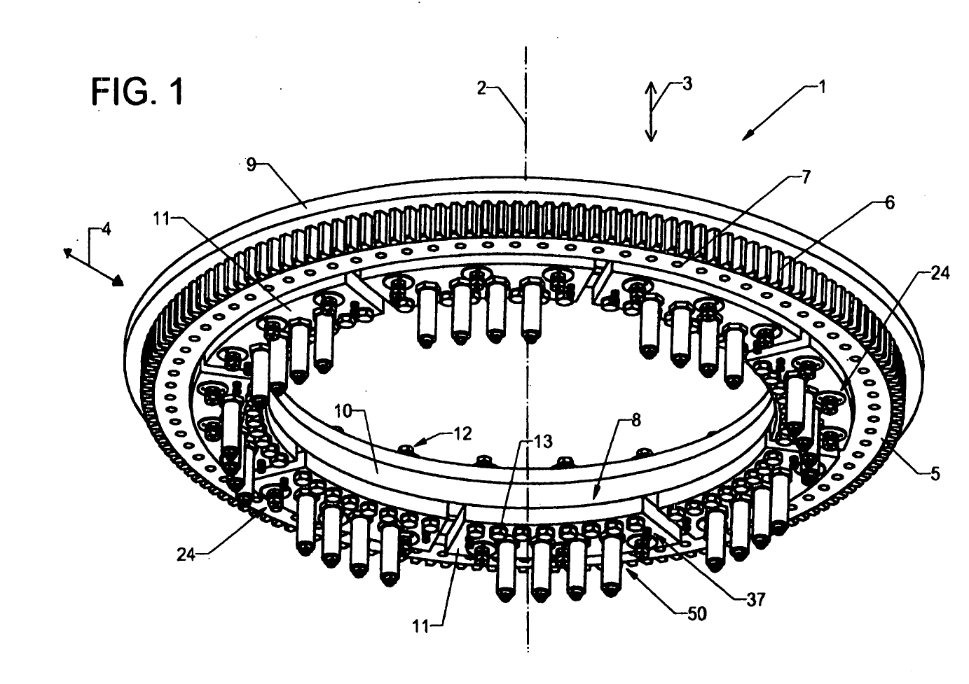

FIG. 1 shows one embodiment of the bearing arrangement 1 according to the invention. Suchlike bearing arrangements 1 are used in wind turbines as so-called azimuth bearings between the nacelle and the tower, whereas the nacelle comprises a machine house and a rotor. In the machine house a power train is mounted on a machine carrier. The power train comprises—depending on the design—in particular a rotor shaft, a rotor bearing and a generator which is connected to the rotor bearing. Mostly the generator is connected to the rotor shaft via a gearing which can be engaged by a brake. As an example in this context is EP 1 291 521 A1 in which a wind turbine is disclosed as described. Therefore an illustration of a wind turbine itself is not necessary in the context of this application. The invention can also be used in different designs of wind turbines.

The azimuth bearing enables a horizontal yawing of the wind turbine according to the wind direction, the so called yaw controlling of the turbine. In order for a self-actuated yawing of the nacelle, the azimuth bearing comprises one or more azimuth drives which are connected in a rotationally fixed manner to the machine carrier of the nacelle. The azimuth bearings must transfer the occurring bearing loads such as thrust load, gyroscopic forces and yaw forces from the machine carrier of the nacelle into the tower. During yaw controlling also referred to as “yawing”—the nacelle is rotated about a vertical axis 2 in the horizontal plane in order to orientate the rotor perpendicular to the wind direction and as a result maximising the energy output.

FIG. 1 shows a bearing arrangement 1 in a perspective view from the bottom upwards. Bearing partner 5, which is designed as rotating rim 5, is closely connectable via boreholes 7 to a tower not shown in the drawings. The other bearing partner 8 of the bearing arrangement 1 is designed as a bearing ring 8 which is rotatable about axis 2 and which axially encompasses the rotating rim 5 and thereby is geometrically interdigitated with the rotating rim 5 in an axial direction 3 and in a radial direction 4. The rotating rim 5 comprises a gear tooth system 6 whereas azimuth drives which are not shown can engage with the gear tooth system. It should be understood that the invention includes bearing arrangements with a bearing rim that comprise an inner gear tooth system or that include bearing partners that are designed in an alternative manner or are interchanged which means that that they comprise a rotatable rotating ring and a torque proof bearing ring. Bearing partners 5, 8 are referred to as rotating rim 5 and bearing ring 8 in the following.

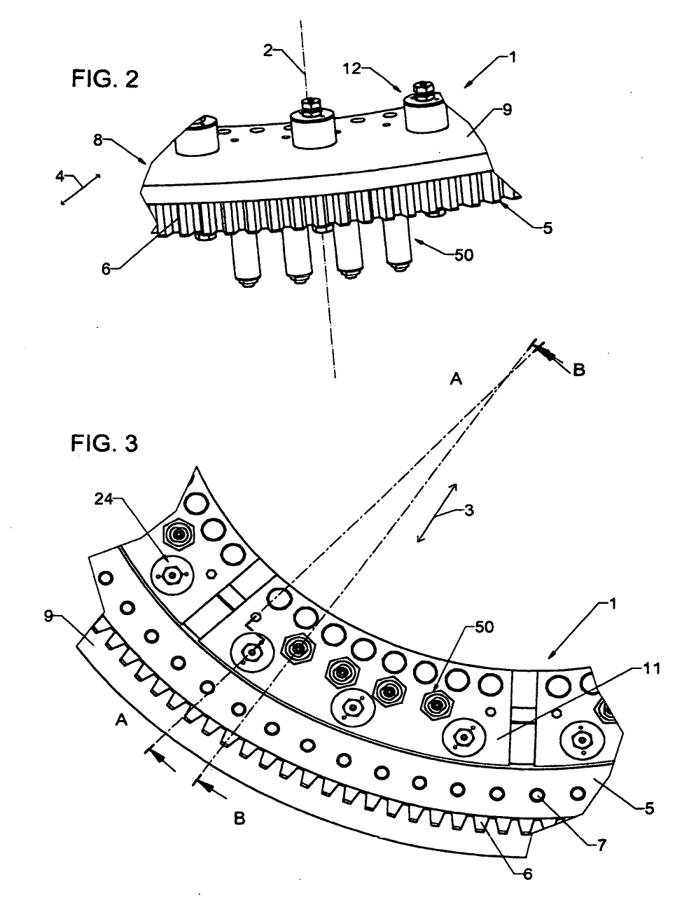

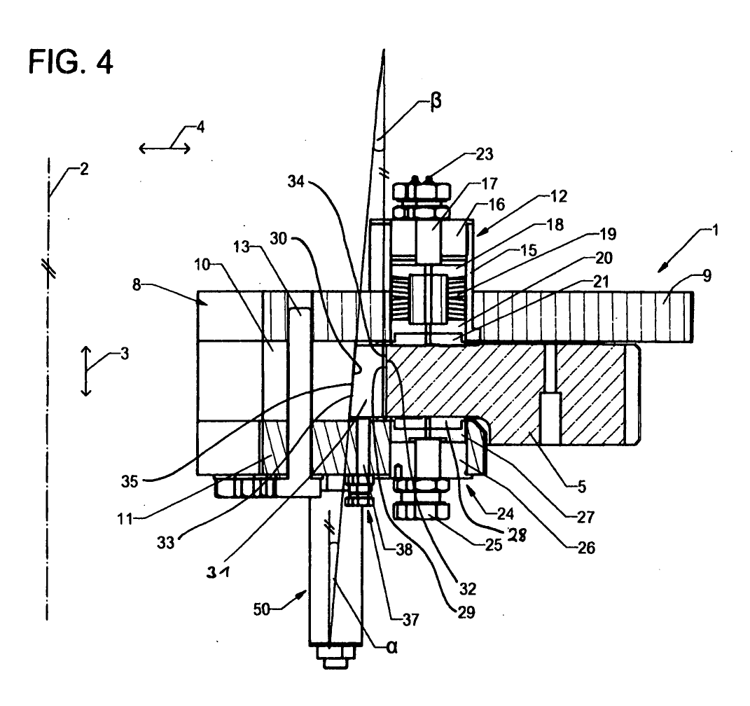

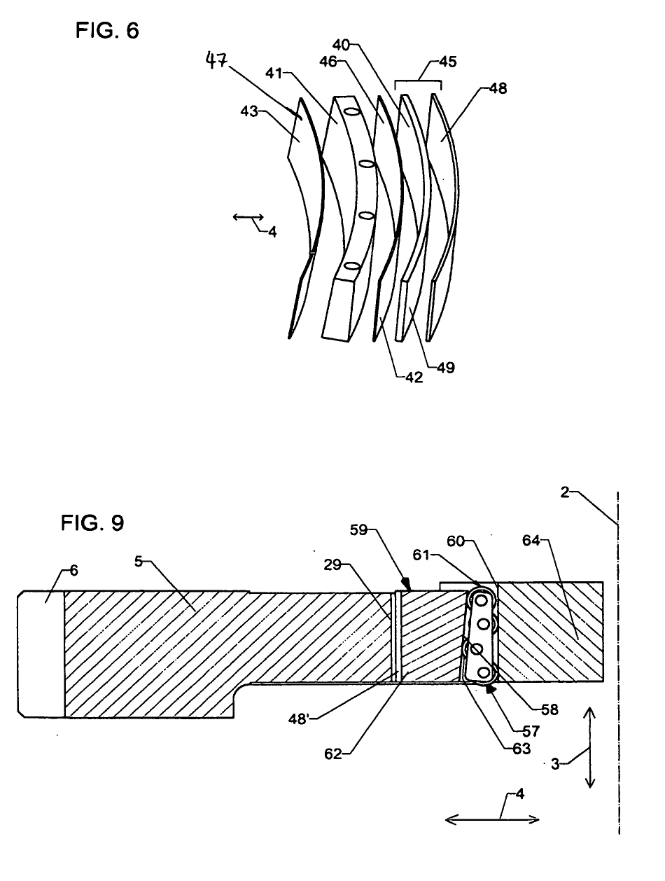

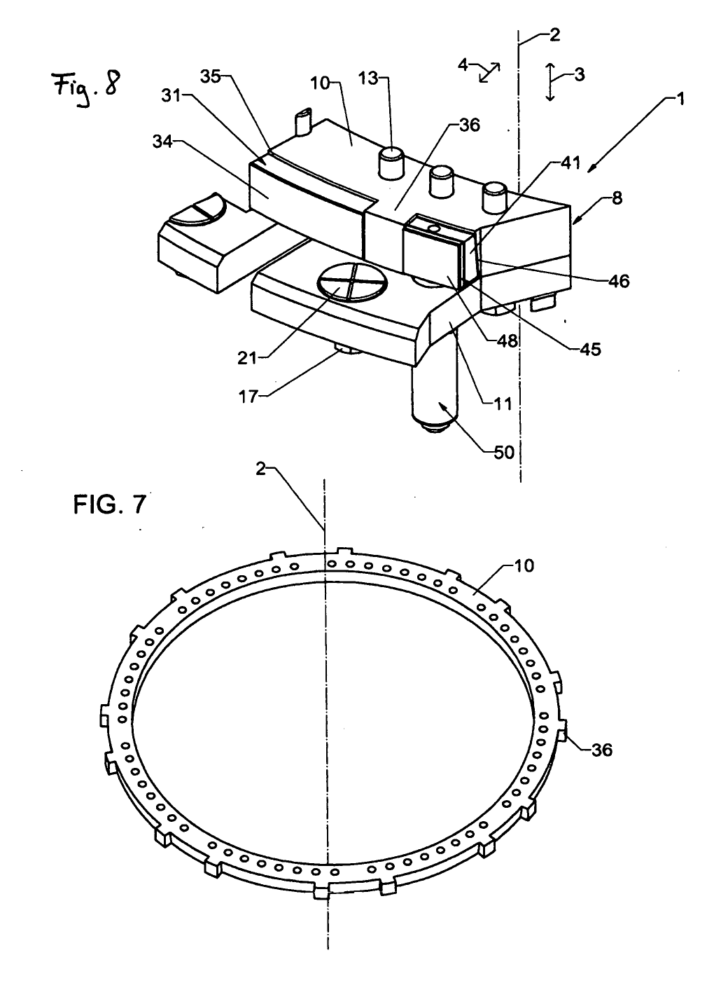

In conjunction with FIGS. 2 and 4 the design details of the bearing arrangement 1 become clearer. Bearing ring 8 comprises inter alia a ring flange 9 which can be designed as a separate component or can be designed integrally with the machine carrier of the nacelle. In the ring flange 9 upper slide devices 12, which can be pre-tensioned, are arranged in a form fit manner. The ring flange 9, and consequently the whole nacelle of the wind turbine, rests mounted on the rotating rim 5 in an axial direction 3 via slide devices 12. The axial interdigitation of the bearing ring 8 is achieved by means of a multitude of locking plates 11 which are connected circularly via a distance ring 10 (FIG. 7) with the ring flange 9. Ring flange 9, distance ring 10 and locking plates 11 are screwed together by means of screws 13, whereby a u-shaped outline of the bearing ring 8 is formed encompassing the rotating rim 5. The clearance-free complete fixation of the bearing ring 8 in an axial direction 3 to the rotating rim 5 is guaranteed by the usage of further lower slide devices 24 which are closely connected to the locking plates 11.

In the following the design of the slide devices 12, 24 will be described with the help of FIG. 4 showing a sectional view along the line A-A of FIG. 3. The upper, pre-tensionable slide device 12 comprises a cylindrical housing 15 which is closed at one end in a form-fitting manner by means of plug 16. An adjustment-screw 17 with counter nut is axially screwed in the plug 16, whereas the shaft of the adjustment screw 17 engages plate springs 19 via spring carrier 18. The plate springs 19 provide a pre-tensional force which is transferred to a mounting plate 20 of a slide lining 21. A lubrication bore 22 which is adapted to be connected to a lubrication feed which is not shown via a lubrication nipple 23 extends through slide device 12. The lower slide device 24 comprises a similar design as upper slide device 12 but is hardly adapted to be pre-tensioned due to the missing springs. An adjustment screw 25 is guided in a thread of a plug 26 which is arranged directly in the locking plate 11 and puts pressure directly on mounting plate 27 of slide lining 28. This way the axial clearance and the axial pretension of the bearing arrangement 1 is adjustable to a desired extend in order to obtain a defined bearing seat and in order to guarantee a sufficiently free movement. FIG. 2 is a top view of the ring flange 9 showing the location of the upper slide device 12 which is adapted to be pre-tensioned, FIG. 1 and FIG. 3 point out the location of the lower slide devices 24.

The bracing of the bearing ring 8 against the rotating rim 5 in a radial direction 4 will be explained with the help of FIG. 4. The radial guiding is in particular carried out by an axially aligned support area 29 which is located on the radially inward orientated surface of the rotating rim 5 and by a support area 30 located at the radially outwards orientated surface of the distance ring 10. Between the support areas 29, 30 a bearing block 31 is arranged to be insertable between the rotating rim 5 and the bearing ring 8 in an axial direction 3. The bearing block 31 is connected in a rotably fixed manner with the distance piece 10. That is why the distance piece 10 comprises cirumferential orientated radially outwards extending projections 36 which receive the tangential forces acting on the bearing block 31 (FIG. 7). The bearing block 31 comprises two bearing areas 32, 33 whereas both of them face a respective support area 29, 30 and run parallel to the same. The support area 29 of the rotating ring 5 and the respective bearing area 32 at bearing block 31 run parallel to axis 2 whereby exclusively radial forces can be transmitted via said areas in a form fit manner. The support area 30 of the distance ring 10 runs slightly bevelled with respect to axis 2 and includes with axis 2 in a plane spanned by axis 2 and the radial direction 4 a small angle α. The bearing area 33 of bearing block 31 runs parallel to the bevelled support area 30. Therefore bearing block 31 comprises a wedge shaped outline which forms in co-operation with the support areas 29, 30 of the bearing partners 5, 8 a transmission gearing basing on the wedge-effect, whereas according to the axial position of the bearing block 31 and in concordance with an increase of force the radial clearance and the pretension between the rotating rim 5 and the distance ring 8 can be adjusted. In order to do so an adjustment device 37 is provided in the locking plate 11 whereas an adjustment screw 38 engages with the bearing block 31 and thereby determines the axial position of the bearing block 31. The bearing areas 32, 33 of the bearing block 31 each comprise a slide lining 34, 35 which as a friction pairing in conjunction with the support areas 29, 30 preferably comprises a low friction coefficient of about 0.09. While mounting the nacelle on the tower, the radial clearance and the pretension is adjusted with the help of the adjustment device 37 and, independently the axial clearance and the axial pretension can be adjusted with the help of slide devices 12, 24. Thus in operation the nacelle will not move in an undesired manner and does not cause excessive friction at the same time. That is why a yawing of the nacelle can be achieved by small-dimensioned and cheap azimuth drives. The slide linings 34, 35 are made of plastic for example and are applied on the bearing block 31 by way of injection molding, thus forming the bearing areas 32 and 33. It is also possible to use self-lubricating materials which may be designed in a form fit manner with respect to the bearing block 31.

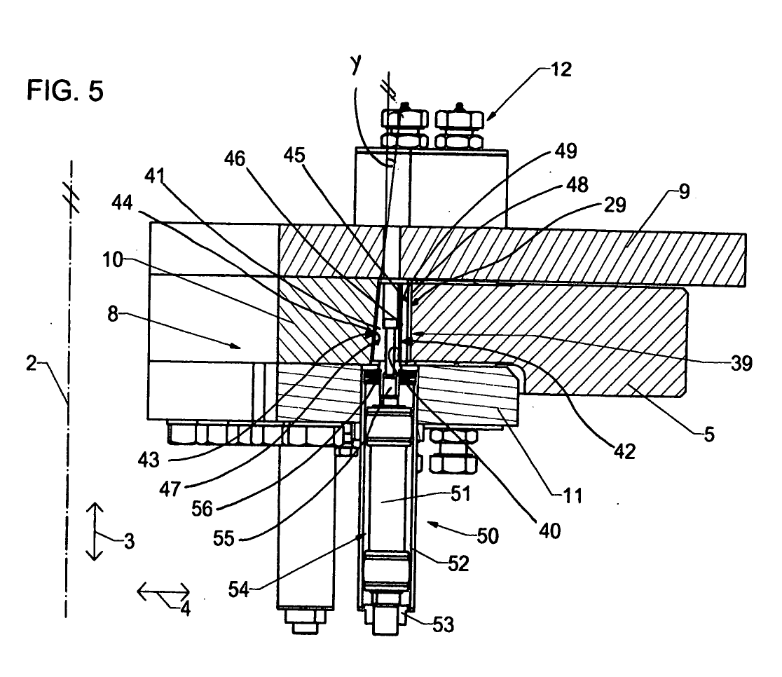

FIG. 5 shows a sectional view along line B-B according to FIG. 2. Here the design of the active braking system 39 of the bearing device 1 is pointed out. Similar to the radial bearing described a wedge shaped bearing block 41 is arranged to be insertable between the distance ring 10 and the rotating rim 5 in an axial direction 3. This bearing block 41 exhibits a radial force on the support area 29 of the rotating rim 5 and the support area 44 of distance ring 10 via the bearing partners 42, 43 in case that the bearing block 41 is pressed between them. The wedge angle β equals the angle γ which is included between the support area 44 of the distance ring 10 and the axis 2.

A brake lining 45 which comprises a lining-support-area 40 and which is adapted to be engaged by the bearing block 41 is arranged between the bearing block 41 and the support area 29 of the rotating rim 5. This brake lining 45 is shown individually with bearing block 41 in FIG. 6, whereas the elements most relevant in terms of the functionality are shown. Brake lining 45 and bearing block 41 are secured against twisting via projections 36 of the distance ring 10. Both of the bearing areas 42, 43 of the bearing block 41 comprise slide linings or coatings 46, 47. The brake lining 45 comprises a backplate 49 carrying the friction material 48. It is possible that a slide lining 46 is integrated in backplate 49 of the brake lining 45. The locking plate 10 carries the actuation device 50 which is used to vary the axial position of the bearing block 41 automatically. The actuation device 50 comprises a supporting tube 52, a pneumatic muscle 54 being arranged at its end 53 in a fixed manner. Furthermore the pneumatic muscle 54 is connected via connecting piece 55 to the bearing block 41. Plate springs 56 are arranged in the inside of the supporting tube 52 which press the bearing block 41 via the connecting piece 55 between the bearing ring 8 and the rotating rim 5 or rather the brake lining 45. Due to this fail safe construction the bearing block 41 constantly exhibits a normal force which is caused by the wedge-effect between the rotating rim 5 and the bearing ring 8 or rather the brake lining 45, thus closing the brake. If the pneumatic muscle 54 is engaged with pressurised air the tubular body 57 inflates, thus, contracts the muscle 54 and pulls back the bearing block against the resilient force of the plate springs 56. In doing so the brake is opened.

FIG. 8 shows a perspective detail of a locking plate 11 and the distance ring 10 of the bearing arrangement 1 without rotating rim 5. Here the arrangement of the bearing blocks 31 serving as radial bearings with slide linings 34, 35 and the arrangement of the bearing blocks 41 serving as active brake with brake lining 45 s is pointed out. The bearing blocks 31, 41 are braced in circumferential direction via the projections 36 of the distance ring 10.

An alternative embodiment of the invention is shown in FIG. 9. Here the bearing block 61 that is serving as a brake comprises means for rolling motion 57 adapted to engage with the lining-support-area 58 of the brake lining 59 and the support area 60 of the distance ring 10. In this context castors 63 can be used which span a plane. These planes serve as bearing surfaces comprising the same spatial alignments as the bearing surfaces 42, 43 according to FIG. 5. This is advantageous since a jamming of the bearing block 61 between the brake lining 59 and the distance ring 64 will be almost imposed, because no sticking friction takes place and the bearing block 61 tends to move out of its position between the rotating rim 5 and the distance ring 64 due to the wedge-effect. According to this embodiment the support area 60 of the distance ring 64 runs parallel to axis 2 and the lining-support-area 58 of the backplate 62 of the brake lining 59 is inclined by angle δ about axis 2. Therefore in opposite to the embodiment according to FIG. 5 an axial force component of the actuation force is exhibited on the brake lining 59 which is absorbed by the ring flange 9.

The combinations of features which are disclosed in the embodiments described above are not supposed to limit the scope of the invention. In fact the features of the different embodiments can be combined. Furthermore the bearing partners are not necessarily designed as rotationally symmetric rings; in particular the u-shaped characteristic of the bearing partner can only apply for certain angular segments or segments of the circle of the bearing arrangement.

### LIST OF REFERENCE NUMERALS

| | |
|---|---|
| 1 | bearing arrangement |
| 2 | axis |
| 3 | axial direction |
| 4 | radial direction |
| 5 | rotating ring |
| 6 | gear tooth system |
| 7 | borehole |
| 8 | bearing ring |
| 9 | ring flange |
| 10 | distance ring |
| 11 | locking plate |
| 12 | slide device |
| 13 | screw |
| 14 | housing |
| 16 | plug |
| 17 | adjustment screw |
| 18 | spring carrier |
| 19 | plate spring |
| 20 | mounting plate |
| 21 | slide lining |
| 22 | lubrication bore |
| 23 | lubrication nipple |
| 24 | slide device |
| 25 | adjustment screw |
| 26 | plug |
| 27 | mounting plate |
| 28 | slide lining |
| 29 | support area |
| 30 | support area |
| 31 | bearing block |
| 32 | bearing area |
| 33 | bearing area |
| 34 | slide lining |
| 35 | slide lining |
| 36 | projection |
| 37 | adjustment device |
| 38 | adjustment screw |
| 39 | brake system |
| 40 | lining-support-area |
| 41 | bearing block |
| 42 | bearing area |
| 43 | bearing area |
| 44 | support area |
| 45 | brake lining |
| 46 | slide lining |
| 47 | slide lining |
| 48 | friction material |
| 49 | backplate |
| 50 | actuation device |
| 51 | tubular body |
| 52 | supporting tube |
| 53 | end |
| 54 | pneumatic muscle |
| 55 | connecting piece |
| 56 | plate spring |
| 57 | means for rolling motion |
| 58 | lining-support-area |
| 59 | brake lining |
| 60 | support area |
| 61 | bearing block |
| 62 | backplate |
| 63 | castor |
| 64 | distance ring |
| α | angle |
| β | wedge angle |
| γ | angle |
| δ | angle |
| α | angle |

1-18. (canceled)

19. Bearing arrangement for a wind turbine for transmitting radial and axial forces,
two bearing partners (5, 8) being provided that are twistable relative to one another about an axis (2),
each bearing partner comprising a support area (29, 30; 44; 60)
between which a bearing block (31, 41; 61) is arranged to be insertable in order to generate a normal force that acts upon the support areas (29, 30, 44; 60),
the bearing block (31, 41; 60) being connected in a rotationally fixed manner to one of the bearing partners (5, 8) and
a friction lining (34, 35, 46; 59) being disposed between the bearing block (31, 41; 61) and the bearing partner (5, 8) which is twistable relative to the bearing block (31, 41; 61), whereas
the friction lining (34, 45; 59) which is designed as brake lining (45; 59) or as slide lining (34) is arranged in a rotationally fixed manner with respect to the bearing partner (8) and whereas
the bearing block (31, 41; 61) is designed wedge shaped in a radial sectional plain, comprising a first bearing area (32; 42) facing the bearing partner (5) and a second bearing area (33; 43) facing the bearing partner (8), whereas the bearing areas (32, 33; 42, 43) run anti-parallel to one another
wherein the support area (29) of the bearing partner (5) which is arranged rotatably with respect to the bearing block (31; 44) running parallel to axis (2) so that no axial transfer of forces can take place in a form fit manner via the support areas.

20. Bearing arrangement according to claim 19 characterized in the friction lining (34) being designed as slide lining (34) whereby each of the support areas (29, 30) run parallel to the corresponding bearing areas (32, 33).

21. Bearing arrangement according to claim 19, wherein the friction lining (45; 59) being designed as brake lining (45; 59) whereas the brake lining (45; 59) and the bearing block (41; 61) are designed as independent components and a lining-support-area (40; 58) being provided on one side of the friction lining (45; 59) facing the bearing block (41; 61) which is adapted to be engaged by the bearing block (41; 61) and which runs parallel to the first bearing area (32).

22. Bearing arrangement according to claim 20, wherein the support area (30; 44; 58) of the of the bearing partner (8) which is arranged in a rotationally fixed manner with respect to the bearing block (31, 41) running anti-parallel to the axis (2) and including angle (α; γ) of 3° to 10° degree particularly 4° degree with the axis.

23. Bearing arrangement according to claim 19, wherein at least one of the bearing areas (42; 43) of the bearing block (41) comprising a slide lining (46; 47).

24. Bearing arrangement according to claim 19, wherein means for rolling motion (57) of a translatory relative movement of the bearing block (61) and the bearing partner (5, 8) or the brake lining (59) being provided at least between the bearing block (61) and the lining-support-area (58) or between the bearing block (61) and the support area (60), whereas the means for rolling motion (57) span plains which substitute the bearing areas (42, 43) and comprise the same spatial alignment as the bearing areas (42, 43).

25. Bearing arrangement according to claim 19, wherein an adjustment device being provided which adjusts a defined position of the bearing block (31, 41) between the bearing partners (5, 8) and which enables a readjustment.

26. Bearing arrangement according to claim 19, wherein an actuation device (50) being provided for varying the position of the bearing block (31, 41) during operation automatically.

27. Bearing arrangement according to claim 19, wherein at least two friction linings (34, 45; 59) being provided whereas one friction lining (45; 59) is designed as brake lining (45; 59) and one friction lining (34) is designed as slide lining (34).

28. Bearing arrangement according to claim 27, wherein a mounting device for the bearing block (41; 61) comprising an actuation device (50) and a mounting device for the bearing block (31) comprising an adjustment device (37) being provided in a bearing partner (8) whereas the mounting devices are mainly designed similar.

29. Wind turbine comprising a nacelle which is mounted rotatable about an axis on a tower, wherein a bearing arrangement (1) according to claim 19 is provided between the tower and the nacelle.
